(19) United States
(12) Patent Application Publication
(10) Pub. No.: US 2026/0311363 A1
(43) Pub. Date: Oct. 8, 2026

(54) INFORMATION PROCESSING APPARATUS, PROGRAM, AND INFORMATION PROCESSING SYSTEM

(71) Applicant: Sony Group Corporation, Tokyo (JP)

(72) Inventors: Yuki TAKEDA, Kanagawa (JP); Hajime WAKABAYASHI, Tokyo (JP); Fujio ARAI, Tokyo (JP); Daniel Makoto TOKUNAGA, Kanagawa (JP); Ryosuke MURATA, Kanagawa (JP); Haruka FUJISAWA, Kanagawa (JP)

(73) Assignee: Sony Group Corporation, Tokyo (JP)

(21) Appl. No.: 19/108,173

(22) PCT Filed: Aug. 8, 2023
(86) PCT No.: PCT/JP2023/028915

§ 371 Date: Mar. 3, 2025

(30) Foreign Application Priority Data
Sep. 14, 2022 (JP) 2022-146510

(51) Int. Cl. G06T 7/73

(52) U.S. Cl. CPC G06T 7/75; G06T 7/74; G06T 2207/30244

(57) ABSTRACT

An information processing apparatus includes: an estimation accuracy determination unit that determines estimation accuracy of a position and a posture of a client estimated on the basis of a position and posture estimation image obtained by imaging a real space transmitted from the client and a 3D map of the real space; and a client specification unit that specifies another client that requests transmission of a 3D map update image for updating the 3D map on the basis of a determination result of the estimation accuracy.

### TECHNICAL FIELD

The present technology relates to an information processing apparatus, a program, and an information processing system.

### BACKGROUND ART

In augmented reality (AR), the same 3D object (virtual object) may be displayed at a specific place in real space for a plurality of clients. For this purpose, it is necessary to specify the position and posture of each client in a common coordinate system. As a means for realizing this, there is a method called a visual positioning system (VPS) for estimating the position and posture of each terminal from a camera image.

The VPS uses the 3D map of the real space, and estimates the position and posture of the client that has captured the camera image in the 3D map coordinate system using a method such as a Perspective-n-Point from the correspondence relationship between the camera image and the features of the 3D map sent from each client. The 3D map includes data such as a three-dimensional feature point (landmark) obtained by modeling an object in a real space, a feature point used at the time of posture estimation, a feature amount, and an image (Key Frame: KF) used for three-dimensional shape estimation.

The estimation accuracy of the position and posture of each client depends on the accuracy of the position of the landmark included in the 3D map. Therefore, when a landmark with low position accuracy is used, there is a problem that the accuracy of the estimation result of the position and posture of the client becomes low.

Therefore, a method of detecting a low-precision landmark included in a 3D map and updating the landmark to a high-precision landmark has been proposed. For example, Patent Document 1 proposes a method in which, when an image of a landscape acquired by a certain client is different from an image of a landscape recorded in a database, a command to prompt the client to acquire additional data is presented to update the database.

### CITATION LIST

### Patent Document

Patent Document 1: Japanese Patent Application Laid-Open No. 2021-170341

### SUMMARY OF THE INVENTION

### Problems to be Solved by the Invention

However, the method of Patent Document 1 functions only in a case where the 3D map can be updated only with sensor data that can be acquired by a client that performs posture estimation. Since a client at a point where posture estimation is performed cannot acquire highly accurate sensor data of an object far from the point, there is a problem that the 3D map cannot be updated for the purpose of improving the accuracy of the landmark.

The present technology has been made in view of such a problem, and an object thereof is to provide an information processing apparatus, a program, and an information processing system capable of updating a 3D map by improving accuracy of a landmark.

### Solutions to Problems

In order to solve the above-described problem, a first technology is an information processing apparatus including: an estimation accuracy determination unit that determines estimation accuracy of a position and a posture of a client estimated on the basis of a position and posture estimation image obtained by imaging a real space transmitted from the client and a 3D map of the real space; and a client specification unit that specifies another client that requests transmission of a 3D map update image for updating the 3D map on the basis of a determination result of the estimation accuracy.

Furthermore, a second technology is a program for causing a computer to execute an information processing method including: determining estimation accuracy of a position and a posture of a client estimated on the basis of a position and posture estimation image obtained by imaging a real space transmitted from the client and a 3D map of the real space; and specifying another client that requests transmission of a 3D map update image for updating the 3D map on the basis of a determination result of the estimation accuracy.

Furthermore, a third technology is an information processing system including: a client that transmits a position and posture estimation image obtained by imaging a real space; an information processing apparatus including: an estimation accuracy determination unit that determines estimation accuracy of a position and a posture of the client estimated on the basis of the position and posture estimation image and a 3D map of the real space; and a client specification unit that specifies another client that requests transmission of a 3D map update image for updating the 3D map on the basis of a determination result of the estimation accuracy; and another client that transmits the 3D map update image in response to a request for transmission of the 3D map update image from the information processing apparatus.

### BRIEF DESCRIPTION OF DRAWINGS

FIG. 1 is a block diagram illustrating a configuration of a client 10.

FIG. 2 is a block diagram illustrating a configuration of a server 20.

FIG. 3 is a block diagram illustrating a configuration of an information processing system 1000.

FIG. 4 is a block diagram illustrating configurations of the information processing system 1000 and an information processing apparatus 100.

FIG. 5 is an explanatory diagram of a 3D map, a key frame, and a landmark.

FIG. 6 is an explanatory diagram of posture estimation results in a case where a landmark has high accuracy and a case where the landmark has low accuracy.

FIG. 7 is a diagram illustrating positions of clients 10 and a landmark in a specific example of the present embodiment.

FIG. 8A is a flowchart illustrating processing in the client 10, and FIG. 8B is a flowchart illustrating processing in the information processing apparatus 100.

FIG. 9A is a flowchart illustrating processing in the client 10, and FIG. 9B is a flowchart illustrating processing in the information processing apparatus 100.

FIG. 10 is a diagram illustrating positions of a landmark, a KF, and a client 10 in a specific example.

FIG. 11A is a flowchart illustrating processing in the information processing apparatus 100, and FIG. 11B is a flowchart illustrating processing in the client 10.

FIG. 12 is an explanatory diagram of a search range.

FIG. 13 is a diagram illustrating a first example of an image acquisition UI.

FIG. 14 is a diagram illustrating a second example of the image acquisition UI.

FIG. 15 is a diagram illustrating a 3D map update image transmitted from a client 10B in a specific example.

FIG. 16 is a diagram illustrating positions of a client 10A and a client 10B specified by the information processing apparatus 100.

### MODE FOR CARRYING OUT THE INVENTION

Hereinafter, an embodiment of the present technology will be described with reference to the drawings. Note that the description will be given in the following order.
<1. Embodiment>
[1-1. Configuration of client 10 and server 20]
[1-2. Configuration of information processing system 1000 and information processing apparatus 100]
[1-3. 3D map, key frame, and landmark]
[1-4. Processing in information processing system 1000 and information processing apparatus 100]
<2. Modifications>

### 1. Embodiment

### [1-1. Configuration of Client 10 and Server 20]

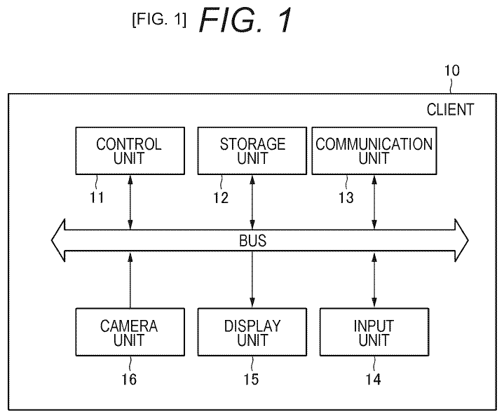

A client 10 included in an information processing system 1000 will be described with reference to FIG. 1. The client 10 includes at least a control unit 11, a storage unit 12, a communication unit 13, an input unit 14, a display unit 15, and a camera unit 16.

The control unit 11 includes a central processing unit (CPU), a random access memory (RAM), a read only memory (ROM), and the like. The CPU controls the entire client 10 and each unit by executing various pieces of processing according to a program stored in the ROM and issuing commands.

The storage unit 12 is, for example, a mass storage medium such as a hard disk or a flash memory. The storage unit 12 stores an AR application, various data, and the like used by the client 10.

The communication unit 13 is a communication module that communicates with a server 20, the Internet, and the like. Specific examples of the communication method may include, regardless of whether wired or wireless, cellular communication, Wi-Fi, Bluetooth (registered trademark), near field communication (NFC), Ethernet (registered trademark), high-definition multimedia interface (HDMI (registered trademark)), universal serial bus (USB), and the like.

The input unit 14 is used by the user to input information, various instructions, and the like to the client 10. When an input is made to the input unit 14 by the user, a control signal corresponding to the input is generated and supplied to the control unit 11. Then, the control unit 11 performs various pieces of processing corresponding to the control signal. The input unit 14 includes, in addition to physical buttons, a touch panel, a touch screen integrally configured with a monitor, and the like.

The display unit 15 is a display device such as a liquid crystal display or an organic EL display that displays an image, a video, a user interface (UI) for the user to use the client 10, and the like.

The camera unit 16 includes a lens, an imaging element, a video signal processing circuit, and the like, and captures a camera image for capturing an image of a real space and transmitting the captured image to the information processing apparatus 100. Note that the camera unit 16 may be a camera as a single device or another device having a camera function in addition to those included in the client 10 itself. In this case, the device transmits the camera image to the client 10 by wired or wireless communication, and the client 10 transmits the camera image captured by the device to the information processing apparatus 100.

The client 10 is configured as described above. Examples of the client 10 include a smartphone, a tablet terminal, a digital camera, a wearable device, a head-mounted display, and a personal computer. The control program that performs the processing according to the present technology may be installed in the client 10 in advance, or may be distributed by download, a storage medium, or the like and installed by the user himself/herself.

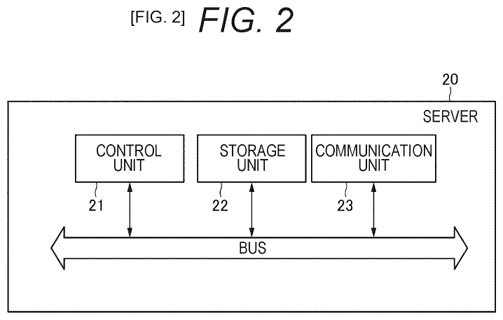

Next, the server 20 constituting the information processing system 1000 will be described with reference to FIG. 2. The server 20 includes at least a control unit 21, a storage unit 22, and a communication unit 23. The control unit 21, the storage unit 22, and the communication unit 23 have functions similar to those of the client 10. The server 20 may be, for example, a cloud server.

### [1-2. Configuration of Information Processing System 1000 and Information Processing Apparatus 100]

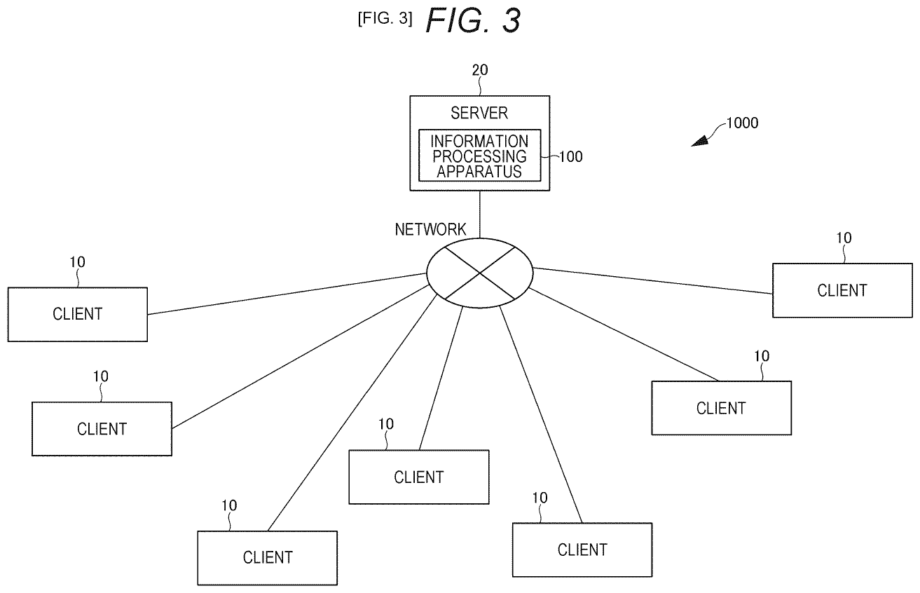

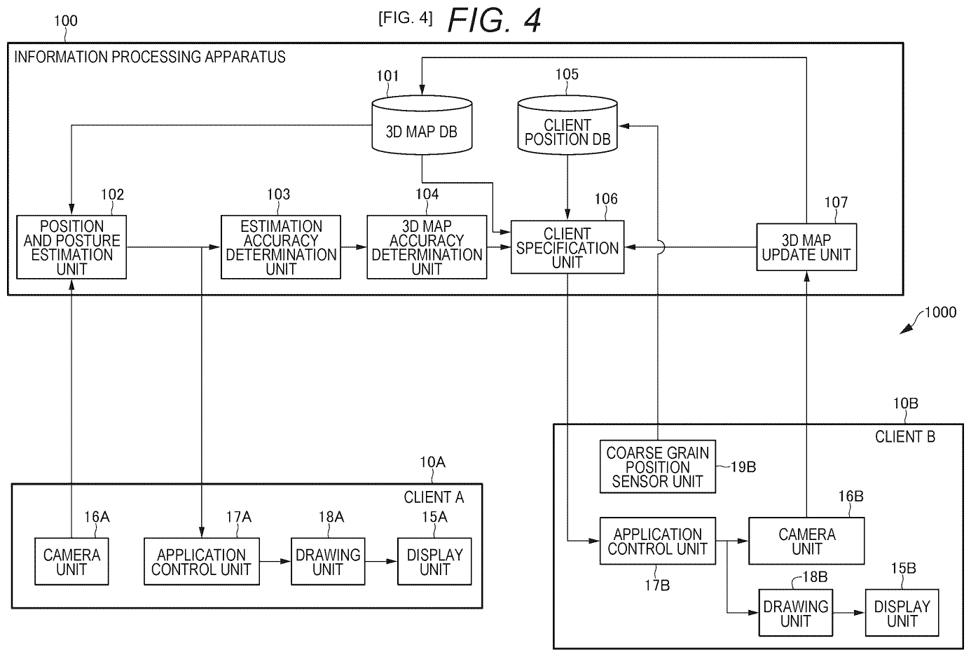

Next, configurations of the information processing system 1000 and the information processing apparatus 100 will be described with reference to FIGS. 3 and 4.

As illustrated in FIG. 3, the information processing system 1000 includes a plurality of clients 10, 10, . . . and a server 20 that performs processing as the information processing apparatus 100. The plurality of clients 10 and the server 20 are connected via a network. The clients 10 include one that transmits a camera image (referred to as a position and posture estimation image) used for position and posture estimation to the information processing apparatus 100 and makes a position and posture estimation request and one that transmits a camera image (referred to as a 3D map update image) used for 3D map update to the information processing apparatus 100 in response to a request from the information processing apparatus 100 (hereinafter, referred to as another client 10). Note that the client 10 functions as an AR device by executing the AR application, but a device that transmits the 3D map update image in response to a request from the information processing apparatus 100 may not function as an AR device. The number of clients 10 is not particularly limited.

In FIG. 4, the information processing apparatus 100 constituting the information processing system 1000 and a client A (indicated as a client 10A) and a client B (indicated as a client 10B) among the plurality of clients 10 are extracted and illustrated. Note that FIG. 4 illustrates only processing blocks related to information and signals related to the present technology.

In FIG. 4, transmission and reception of data between the client 10A and the information processing apparatus 100 and transmission and reception of data between the client 10B and the information processing apparatus 100 are executed by communication functions included in the client 10A, the client 10B, and the server 20.

The client 10A functions as an AR device by executing an AR application. The client 10A requests the information processing apparatus 100 to estimate the position and posture of the client 10A by transmitting the position and posture estimation image captured by the camera unit 16.

Further, the client 10A includes an application control unit 17A and a drawing unit 18A in addition to the configuration illustrated in FIG. 1.

The application control unit 17A performs processing based on an application for using the information processing system 1000. The application control unit 17A performs processing related to the AR application executed by the client 10A, acquires the position and posture estimation result transmitted from the information processing apparatus 100, and outputs the position and posture estimation result to the drawing unit 18A.

The drawing unit 18A generates an output image by drawing a virtual object on the basis of the position and posture estimation result transmitted from the information processing apparatus 100, and outputs the output image to the display unit 15A. As a result, the output image is displayed on the display unit 15A. The virtual object is, for example, a character, a figure, an object, a character arranged on an image obtained by imaging a real space, or the like indicating information in a map service, but is not limited thereto, and may be any object.

The application control unit 17A and the drawing unit 18A are realized by the client 10A executing an AR application, and the application may be installed in the client 10A in advance, or may be distributed by download, a storage medium, or the like and installed by the user himself/herself. In addition, the client 10A may have functions as the application control unit 17A and the drawing unit 18A in advance.

Upon receiving the transmission request for the 3D map update image from the information processing apparatus 100, the client 10B transmits the camera image captured by a camera unit 16B as the 3D map update image to the information processing apparatus 100.

The client 10B includes a coarse granularity position sensor unit 19B, an application control unit 17B, and a drawing unit 18B in addition to the configuration illustrated in FIG. 1.

The coarse granularity position sensor unit 19B is a sensor that acquires position information such as a global navigation satellite system (GNSS) or a global positioning system (GPS), and acquires coarse granularity position information indicating the position of the client 10B with accuracy of, for example, about several tens to several hundreds of meters. The coarse granularity position sensor unit 19B periodically acquires coarse granularity position information, and the client 10B transmits the coarse granularity position information to the information processing apparatus 100. In addition, the coarse granularity position sensor unit 19B may acquire the coarse granularity position information using base station information of a mobile line, an access point name of Wi-Fi, or the like. Note that the coarse granularity position information is used to specify the approximate position of the client 10B, and thus does not need to be highly accurate position information. However, the client 10B may transmit highly accurate position information, and the coarse granularity position sensor unit 19B does not exclude acquisition of highly accurate position information. Furthermore, the client 10B may transmit information indicating the direction in which the client 10B is facing to the information processing apparatus 100 together with the coarse granularity position information using a geomagnetic sensor or the like.

The application control unit 17B performs processing based on an application for using the information processing system 1000. The application control unit 17B controls drawing of a UI by the drawing unit 18B, display on a display unit 15B, and the like in order to present a transmission request for the 3D map update image from the information processing apparatus 100 to the user. Furthermore, imaging of a camera image by the camera unit 16 and the like are also controlled.

The drawing unit 18B draws a UI or the like for presenting a transmission request for the 3D map update image to the user, and outputs a drawing result to the display unit 15A. The drawing result is displayed on the display unit 15B.

Note that the client 10B may include an inertial measurement unit (IMU), a light detection and ranging (Light Detection and Ranging, Laser Imaging Detection and Ranging), a time of flight (ToF) sensor, or the like, and transmit the sensing data acquired by these sensors to the information processing apparatus 100 as 3D map update data or coarse granularity position information. Furthermore, information such as GNSS, mobile line base station information, and Wi-Fi access point name may also be used together as the 3D map update data.

The client 10B may function as the AR device by executing the AR application or may not function as the AR device.

The information processing apparatus 100 includes a 3D map database (DB) 101, a position and posture estimation unit 102, an estimation accuracy determination unit 103, a 3D map accuracy determination unit 104, a client position DB 105, a client specification unit 106, and a 3D map update unit 107. In the present embodiment, the storage unit 22 of the server 20 functions as the 3D map DB 101 and the client position DB 105, but each DB may be configured by different storage media.

The 3D map DB 101 is a database that stores a 3D map that models a real space. It is assumed that there is a plurality of 3D maps for each point in the real space, and a plurality of 3D maps generated in advance is stored in the 3D map DB 101. The 3D map can be generated by simultaneously estimating a three-dimensional shape and an imaging point on the basis of a plurality of camera images having different viewpoints using a technique such as structure from motion (SEM) or visual inertial odometry (VIO).

The position and posture estimation unit 102 estimates the position and posture of the client 10A using the VPS on the basis of the correspondence relationship between the position and posture estimation image transmitted from the client 10A and the 3D map acquired from the 3D map DB 101. In the VPS, the position and posture of the client 10A are estimated in the 3D map coordinate system using a method such as a Perspective-n-Point from the correspondence relationship between the position and posture estimation image and the feature point and the feature amount of the 3D map.

The position and posture estimation result by the position and posture estimation unit 102 is transmitted to the client 10 that has made the position and posture estimation request. In the example of FIG. 4, the position and posture estimation unit 102 estimates the position and posture of the client 10A on the basis of the correspondence relationship between the position and posture estimation image transmitted from the client 10A and the 3D map, and the information processing apparatus 100 transmits the position and posture estimation result to the client 10A. The drawing unit 18A of the client 10A draws the virtual object in AR using the position and posture estimation result.

The estimation accuracy determination unit 103 evaluates the accuracy of the position and posture estimation result by the position and posture estimation unit 102. In a case where the accuracy of the position and posture estimation result is low, the 3D map accuracy determination unit 104 determines the accuracy of the 3D map.

The 3D map accuracy determination unit 104 determines the accuracy of the landmark used for estimating the position and posture of the client 10A among the landmarks included in the 3D map. In a case where the accuracy of the landmark is low, processing is performed in which the client specification unit 106 specifies the client 10 that requests transmission of the 3D map update image.

The client position DB 105 is a database that stores coarse granularity position information transmitted from a plurality of clients 10 connected to the server 20.

The client specification unit 106 refers to the coarse granularity position information stored in the client position DB 105 to specify the client 10 that requests transmission of the 3D map update image. In the example of FIG. 4, it is assumed that the client 10B receives the transmission request for the 3D map update image specified by the client specification unit 106.

The 3D map update unit 107 updates the 3D map update image transmitted from the client 10B and the 3D map used for the position and posture estimation of the client 10A by the position and posture estimation unit 102 using the computer resource of the server 20. The computer resource is an occupation amount of hardware of the server 20 such as an execution time in the server 20, a utilization rate of a processor, and an occupation amount of the storage unit 22.

The information processing system 1000 and the information processing apparatus 100 are configured as described above. In the present embodiment, the information processing apparatus 100 operates in the server 20, but the server 20 may have a function as the information processing apparatus 100 in advance, or the information processing apparatus 100 and the information processing method may be implemented by the server 20 having a function as a computer executing a program. Furthermore, the control unit 21 may function as the information processing apparatus 100 by executing the program. The program may be installed in the server 20 in advance, or may be distributed by downloading, a storage medium, or the like and installed by a user or the like. Furthermore, the information processing apparatus 100 may be configured as a single apparatus. Furthermore, the information processing apparatus 100 is not limited to the server 20, and may operate on a personal computer, a smartphone, a tablet terminal, or the like.

### [1-3. 3D Map, Key Frame, and Landmark]

Here, the 3D map and the keyframes and landmarks included in the 3D map will be described.

Using the 3D map of the real space, the VPS estimates the position and posture of the client 10 that has captured the position and posture estimation image in the 3D map coordinate system by using a method such as Perspective-n-Point from the correspondence relationship between the features of the 3D map and the camera image as the position and posture estimation image transmitted from the client 10. The 3D map includes data such as three-dimensional feature points (landmarks) modeled by estimating an object in the real space, feature points and feature amounts used at the time of posture estimation, an image (Key Frame: KF) used for three-dimensional shape estimation, and coarse granularity position information. Imaging position information of the KF used for estimating the landmark is recorded in the landmark. Examples of the landmark include a position of a vertex of an acute angle portion of the object.

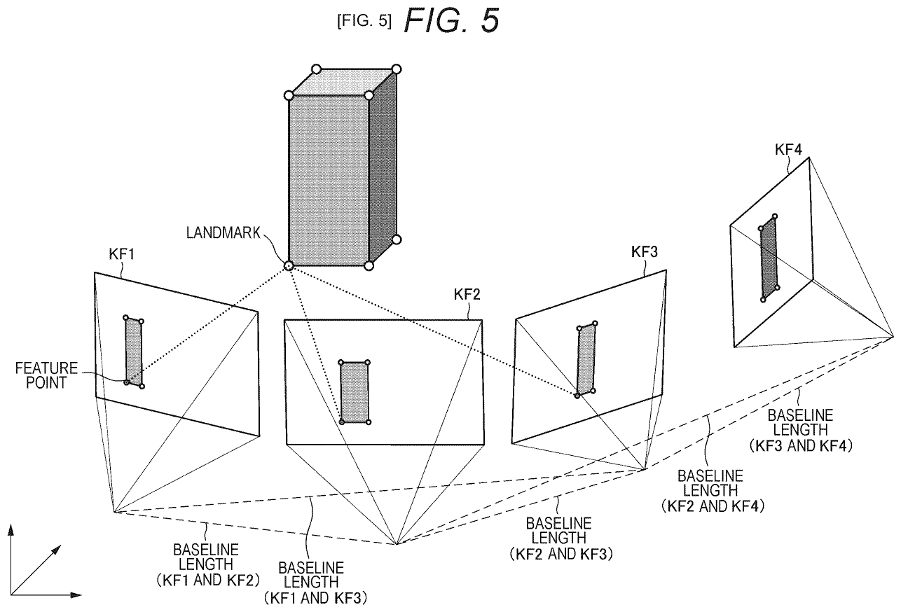

The 3D map can be generated by estimating the three-dimensional shape and the imaging position and posture of the KF on the basis of a plurality of KFs having different viewpoints using a technique such as SEM or VIO. As illustrated in FIG. 5, these techniques perform triangulation using a positional relationship of feature points commonly appearing in each KF by using a plurality of KFs (KF1 to KF4 in FIG. 5) having different viewpoints, and estimate the position of the landmark and the imaging position and posture of the KF by optimizing the result as a whole.

Since the position of the landmark is estimated using triangulation, the accuracy of the estimated position of the landmark depends on the accuracy of the position of the feature point in KF and the distance (baseline length) between the two KFs used for estimation. The accuracy of the position of the feature point in the KF is inversely proportional to the distance of the object from which the landmark is detected from the position of the KF. This is because the size of the object projected on the image (KF) decreases as the distance from the imaging point of KF to the object increases, and thus the size of the object represented by one pixel increases in proportion to the distance. Therefore, in a case where the landmark in the object far from the imaging position of the KF is estimated with a short base line length, the accuracy of the estimated position of the landmark becomes low.

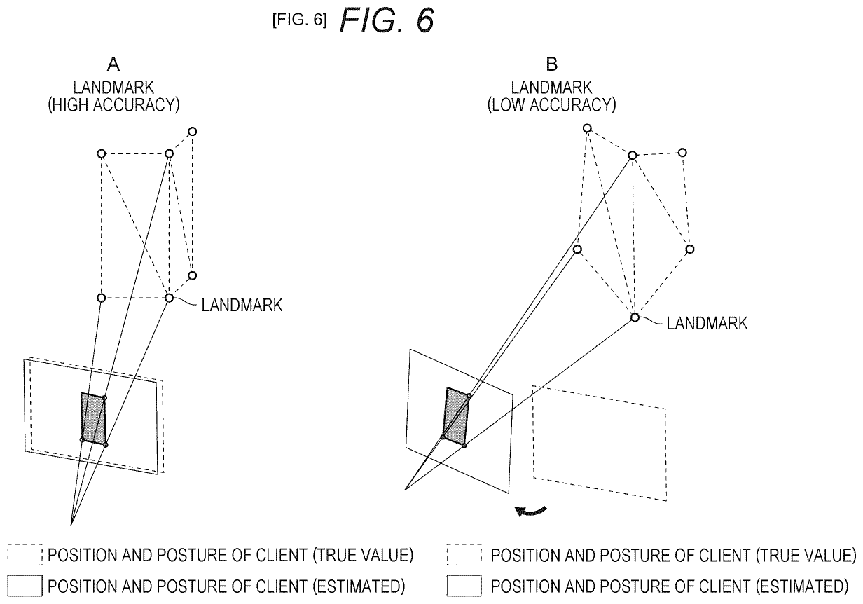

The position and posture of the client 10A are estimated using the position and posture estimation image transmitted by the client 10A and the 3D map acquired from the 3D map DB 101. The estimation accuracy of the position and posture of the client 10A depends on the position accuracy of the landmark used for estimation in the 3D map. Therefore, as illustrated in FIG. 6A, the use of landmarks with high positional accuracy (indicated by six white points) increases the estimation accuracy of the position and posture of the client 10A. However, as illustrated in FIG. 6B, the use of landmarks with low positional accuracy (indicated by six white points) also decreases the estimation accuracy of the position and posture of the client 10A.

### [1-4. Processing in Information Processing System 1000 and Information Processing Apparatus 100]

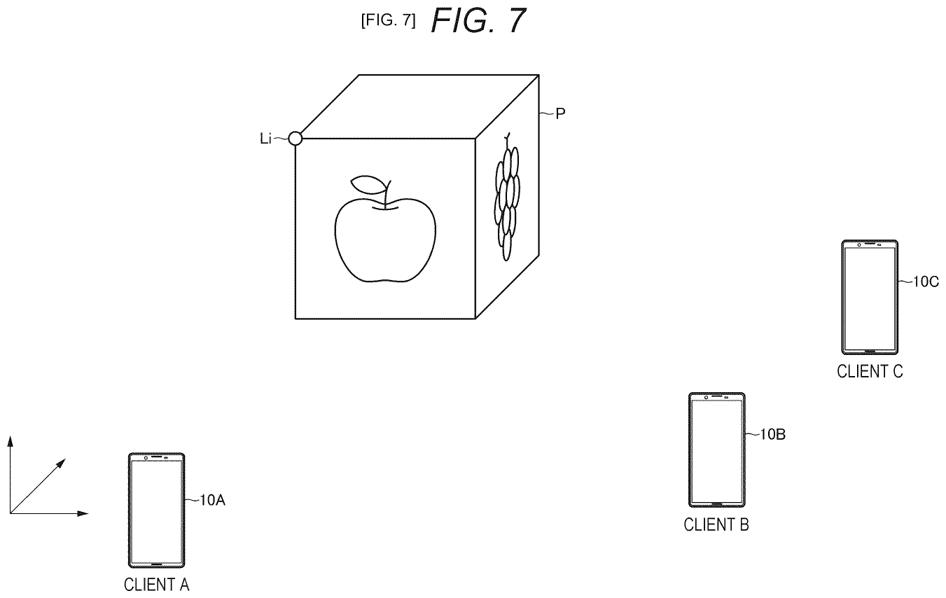

Next, processing in the information processing system 1000 and the information processing apparatus 100 will be described. Here, as illustrated in FIG. 7, it is assumed that there are a client 10A, a client 10B, and a client 10C which are smartphones in the real space, and a landmark Li is a corner of an object P existing in the real space. It is assumed that the client 10A requests the information processing apparatus 100 to estimate the position and posture, and the client 10B and the client 10C are other clients in the claims that may be requested to transmit the 3D map update image from the information processing apparatus.

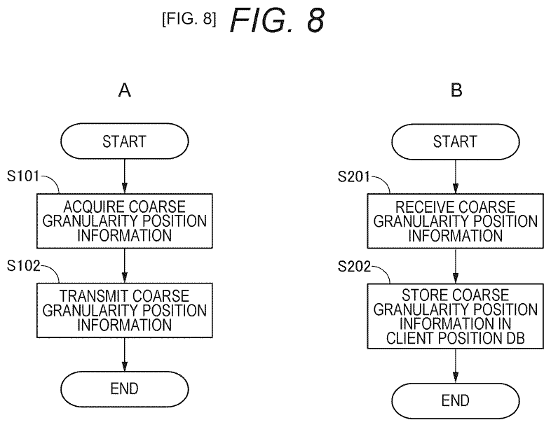

As illustrated in FIG. 8A, first, in step S101, the coarse granularity position sensor unit 19B of the client 10B acquires coarse granularity position information.

Next, in step 102, the client 10B transmits the coarse granularity position information to the information processing apparatus 100.

The client 10C performs the processing of FIG. 8A similarly to the client 10B. However, the client 10B and the client 10C do not need to perform the processing of FIG. 8A at the same timing.

Next, as illustrated in FIG. 8B, in step S201, the information processing apparatus 100 receives the coarse granularity position information transmitted from the client 10B.

Next, in step S202, the information processing apparatus 100 stores the coarse granularity position information in the client position DB 105.

The information processing apparatus 100 similarly performs the processing of FIG. 8B for the coarse granularity position information transmitted from the client 10C.

The client 10B, the client 10C, and the information processing apparatus 100 periodically perform the processing from step S101 to step S202 at predetermined time intervals. As a result, the latest coarse granularity position information of the client 10B and the client 10C is periodically stored in the client position DB 105.

Note that, although only the client 10B and the client 10C are described as an example, in a case where there is a plurality of clients 10 connected to the server 20 and using the information processing system 1000, all the clients 10 transmit the coarse granularity position information to the information processing apparatus 100, and the coarse granularity position information of the plurality of clients 10 is stored in the client position DB 105. Furthermore, the client 10A may also transmit the coarse granularity position information to the information processing apparatus 100. This is because, in a case where another client 10 makes the position and posture estimation request, there is a possibility that the client 10A also receives a transmission request for the 3D map update image from the information processing apparatus 100.

Next, a posture estimation request from the client 10A using the AR application and processing in the information processing apparatus will be described.

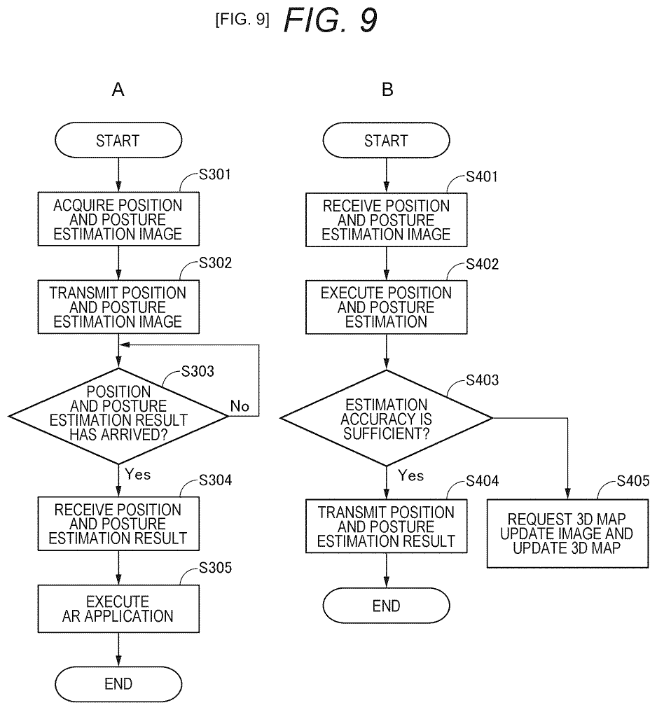

First, as illustrated in FIG. 9A, in step S301, a camera unit 16A captures an image of a real space on the basis of an input operation of the user A using the client 10A to acquire a position and posture estimation image.

Next, in step 302, the client 10A transmits the position and posture estimation image to the information processing apparatus 100.

Then, in step S303, the client 10A waits until the position and posture estimation result arrives from the information processing apparatus 100 (No in step S303).

Next, processing in the information processing apparatus 100 will be described with reference to FIG. 9B. In step S401, the information processing apparatus 100 receives the position and posture estimation image transmitted from the client 10A.

Next, in step S402, the position and posture estimation unit 102 estimates the position and posture of the client 10A using the position and posture estimation image and the 3D map acquired from the 3D map DB 101.

The position and posture estimation unit 102 extracts feature points and feature amounts of the received position and posture estimation image, compares the feature points and feature amounts with the feature points, feature amounts, and the like of each of the plurality of 3D maps stored in the 3D map DB 101, and uses a 3D map in which the feature points and feature amounts match or approximate to each other as a 3D map used for estimating the position and posture of the client 10A. Furthermore, there is also a method of determining a 3D map covering a range in which the client 10A exists as a 3D map used for estimating the position and posture of the client 10A on the basis of coarse granularity position information such as GPS data transmitted by the client 10A and coarse granularity position information included in the 3D map.

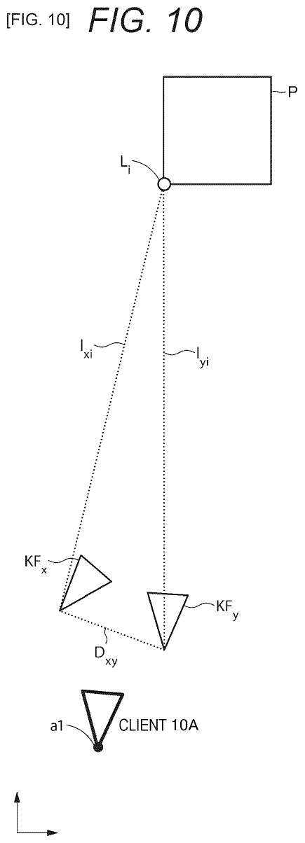

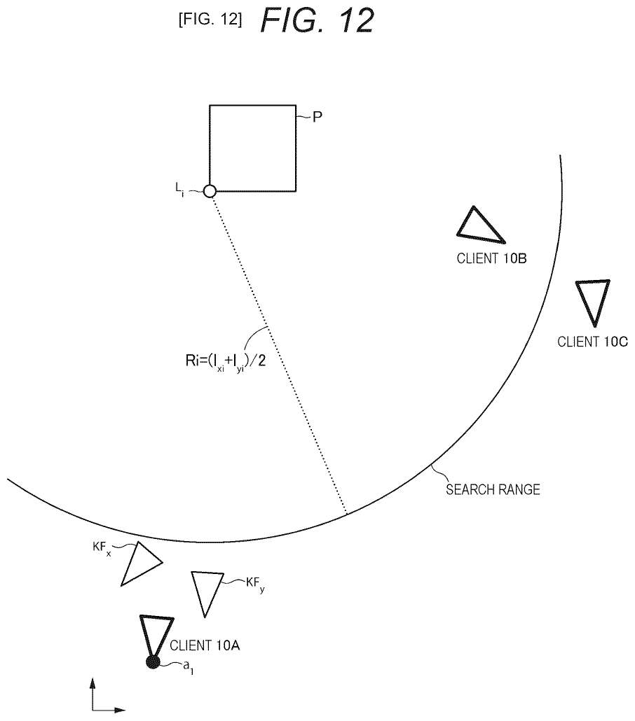

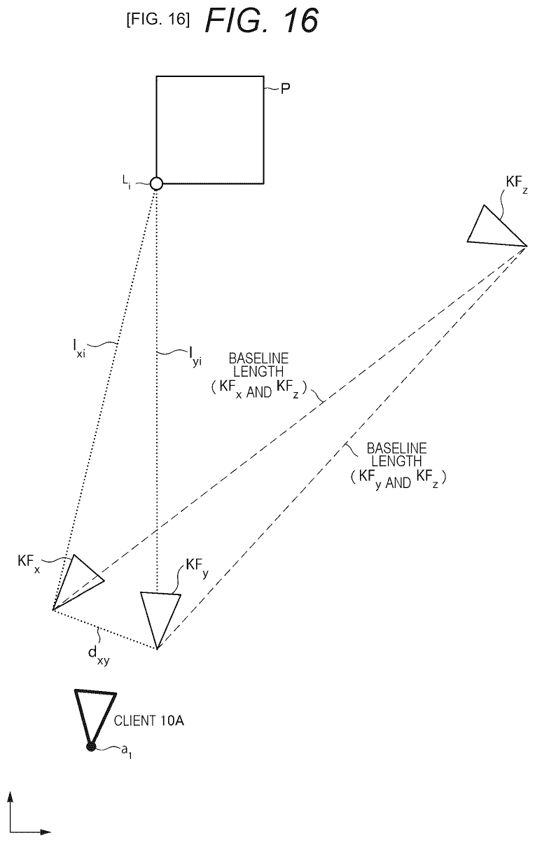

Here, as illustrated in FIG. 10, it is assumed that the client 10A captures a position and posture estimation image necessary for the posture estimation request at a current location point a1. Note that, in FIG. 10, a method using a frustum called viewing frustum is used as a method of expressing the direction of the camera and the direction of the KF. The short side of the triangle represents the imaging surface on which the KF is imaged in the KF, and represents the imaging surface (the direction in which the lens faces) of the camera unit 16 in the client 10. The similarity applies to FIGS. 12 and 16 described later.

Here, it is assumed that KFx and KFy, which are two KFs, and the landmark Li are included in the 3D map, and that KFx and KFy and the current location point a1 of the client 10A are in the positional relationship illustrated in FIG. 10. In this case, the position and posture estimation unit 102 of the information processing apparatus 100 estimates the position and posture of the client 10A by the VPS on the basis of the position and posture estimation image transmitted from the client 10A and the landmark Li included in the 3D map.

Next, in step S403, the estimation accuracy determination unit 103 determines the accuracy of the position and posture estimation result by the position and posture estimation unit 102. The accuracy of the position and posture estimation result can be determined by calculating the estimation accuracy of the position and posture estimation result and comparing the estimation accuracy with a predetermined threshold (first threshold).

As a method of calculating the estimation accuracy, for example, there is a method of using an average value of distances between all the landmarks used for the position and posture estimation and the position of the client 10A estimated by the position and posture estimation unit 102. In a case where the average value is below the first threshold value, it is determined that the estimation accuracy is high, and in a case where the average value is above the first threshold value, it is determined that the estimation accuracy is low. The first threshold value may be set to a specific value in advance by an operator of the information processing system 1000, a developer of the AR application, or the like, or may be changed by the operator, the developer, or the like according to an operation status of the information processing system 1000 or the AR application.

In a case where the estimation accuracy is high, the processing proceeds to step S404 (Yes in step S403). Then, in step S404, the information processing apparatus 100 transmits the position and posture estimation result to the client 10A.

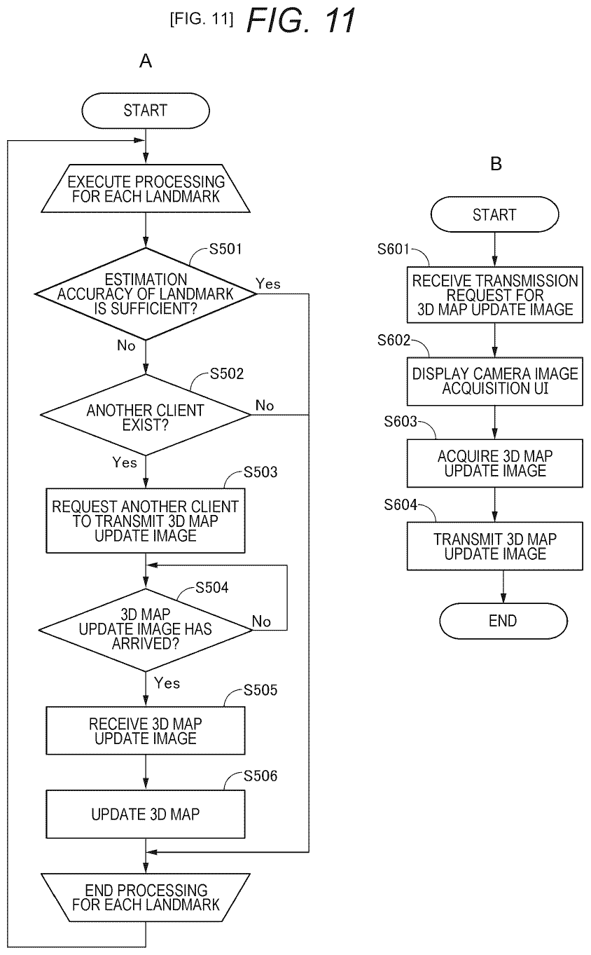

On the other hand, in a case where the estimation accuracy is low, the processing proceeds to step S405 (No in step S403), and the information processing apparatus 100 performs a transmission request for the 3D map update image and the 3D map update. The processing in step S405 will be described later with reference to FIG. 11.

Processing of the client 10A after the information processing apparatus 100 transmits the position and posture estimation result to the client 10A in step S404 will be described with reference to FIG. 9A. When the information processing apparatus 100 transmits the position and posture estimation result to the client 10A, the processing proceeds from step S303 to step S304 (Yes in step S303), and the client 10A receives the position and posture estimation result.

Then, in step S305, the client 10A executes the AR application using the position and posture estimation result. The application control unit 17A outputs the position and posture estimation result transmitted from the server 20 to the drawing unit 18A, and the drawing unit 18A draws a virtual object on the basis of the position and posture estimation result to generate an output image and outputs the output image to the display unit 15 A. As a result, the output image is displayed on the display unit 15A.

Next, the transmission request for the 3D map update image and the 3D map update in step S405 described above will be described with reference to FIG. 11. In a case where the estimation accuracy of the position and posture estimation result of the client 10A is low, the processing illustrated in FIG. 11A is performed for each landmark included in the 3D map used for the position and posture estimation of the client 10A. The processing illustrated in FIG. 11A is processing of updating the 3D map in order to improve the estimation accuracy of the position and posture of the client 10A.

First, in step S501, the 3D map accuracy determination unit 104 determines the estimation accuracy of the landmark Li included in the 3D map and used for estimating the position and posture of the client 10. Here, the estimation accuracy of the landmark Li is set to Ei.

As illustrated in FIG. 10, assuming that a distance between imaging positions of two KFs (KFx, KFy) used for triangulation is Dxy, a distance between the imaging position of KFx and the landmark Li is lxi, and a distance between the imaging position of KFy and the landmark Li is lyi, the estimation accuracy Ei can be calculated by the following Formula 1.

$${E}_{i} = \frac{{d}_{xy}}{{l}_{xi} + {l}_{yi}} \qquad [ Math . 1 ]$$

In a case where the estimation accuracy Ei is lower than a predetermined threshold (second threshold), it is determined that the estimation accuracy of the landmark Li is low, and the processing proceeds to step S502 (No in step S501).

The second threshold value may be set to a specific value in advance by the operator of the information processing system 1000, the developer of the AR application, or the like, or may be changed by the operator, the developer, or the like according to the operation status of the information processing system 1000 or the AR application. Note that, although the estimation accuracy Ei of the landmark Li is calculated on the basis of two KFs in FIG. 10, the estimation accuracy of the landmark may be calculated on the basis of three or more KFs by a similar method.

Next, in step S502, the client specification unit 106 specifies another client 10 that can request transmission of the 3D map update image necessary for updating the landmark Li on the basis of the coarse granularity position information in the search range that is a predetermined range based on the landmark Li. The another client 10 is a client 10 different from the client that has transmitted the position and posture estimation image and has made the position and posture estimation request. To update the landmark Li, a 3D map update image obtained by imaging the landmark Li from another position is required. Therefore, the client specification unit 106 uses the client position DB 105 to specify another client 10 on the basis of the coarse granularity position information transmitted from another client 10 within the search range based on the landmark Li as illustrated in FIG. 12. The search range is a range determined on the basis of the imaging position of the key frame included in the 3D map and the distance between the landmarks. More specifically, the search range can be defined as a circle having a radius Ri based on the landmark Li, and the radius Ri can be calculated by the following Formula 2 using, for example, a distance lxi between imaging positions of KFx included in the 3D map from the landmark Li and a distance lyi between the landmark Li and KFy included in the 3D map. However, the search range is not limited to a circular shape, and may be a rectangular range or a range of an arbitrary shape.

$${R}_{i} = \frac{{l}_{xi} + {l}_{yi}}{2} \qquad [ Math . 2 ]$$

Note that the value “2” of the denominator in Formula 2 is not a fixed value but is merely an example, and the value of the denominator is not limited to 2. The radius Ri decreases as the value of the denominator of Formula 2 increases, so that the size of the search range can be adjusted by adjusting the value of the denominator.

In a case where another client 10 exists in the search range, the processing proceeds to step S503 (Yes in step S502). Here, as an example, it is assumed that the client 10B is detected from the search range as illustrated in FIG. 12. Note that since the client 10C exists outside the search range, the client specification unit 106 does not specify the client 10C as the client 10 that can request transmission of the 3D map update image.

Next, in step S503, the information processing apparatus 100 requests the client 10B specified by the client specification unit 106 to transmit the 3D map update image.

Then, in step S504, the information processing apparatus 100 waits until the 3D map update image arrives from the client 10B (No in step S504).

Processing of the client 10B after the information processing apparatus 100 requests the client 10B to transmit the 3D map update image in step S503 will be described with reference to FIG. 11B.

When the information processing apparatus 100 requests transmission of the 3D map update image, the client 10B receives the transmission request for the 3D map update image in step S601.

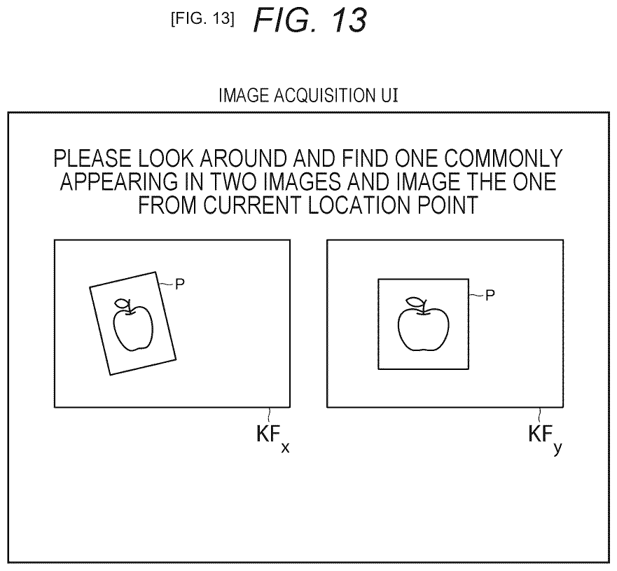

Next, in step S602, under the control of the application control unit 17B, the client 10B displays a UI (image acquisition UI) for prompting the user B who uses the client 10B to capture the 3D map update image on the display unit 15B. The client 10B exists in the search range based on the landmark Li, but the user B using the client 10B does not know where the landmark Li exists. Therefore, by presenting KFx and KFy used for estimating the landmark Li to the user B, the user B can search the landmark Li and capture a camera image around the landmark Li. As the image acquisition UI, for example, a UI as illustrated in FIG. 13 can be considered.

In the image acquisition UI illustrated in FIG. 13, KF (KFx, KFy) included in the updated 3D map and a message prompting capturing of a camera image as a 3D map update image are displayed. Since the object P having the landmark Li appears in both of KFx and KFy displayed on the image acquisition UI, the user B can capture the 3D map update image by using the object P as a mark.

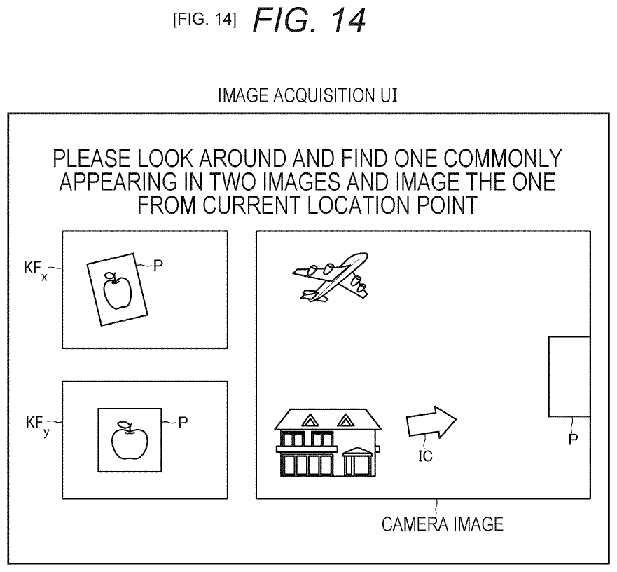

Furthermore, in a case where a sensor that detects an azimuth is mounted on the client 10B, as illustrated in FIG. 14, an icon IC indicating a direction in which the object P including the landmark Li exists may be superimposed and presented on the camera image together with KF. This camera image is an image currently captured by the client 10B. The icon IC is superimposed and displayed on the camera image in a state where the current camera image is always displayed on the display unit 15B like a through image at the time of capturing a moving image.

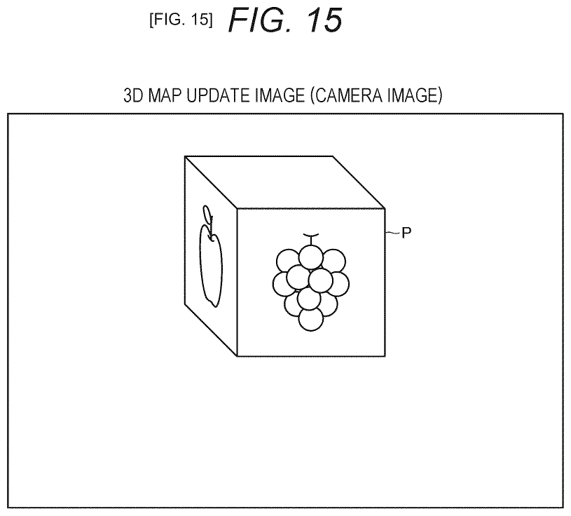

Next, in step S603, in response to the input operation of the user B with reference to the image acquisition UI, the client 10B images the surrounding real space to acquire the 3D map update image. Here, it is assumed that a camera image as illustrated in FIG. 15 is captured at a position illustrated in FIG. 12.

Then, in step S604, the client 10B transmits the camera image illustrated in FIG. 15 to the information processing apparatus 100 as a 3D map update image.

Processing of the information processing apparatus 100 after the client 10B transmits the 3D map update image to the information processing apparatus 100 in step S604 will be described with reference to FIG. 11A.

When the client 10B transmits the 3D map update image to the information processing apparatus 100, the processing proceeds from step S504 to step S505 (Yes in step S504), and the information processing apparatus 100 receives the 3D map update image in step S505.

Next, in step S506, the 3D map update unit 107 updates the 3D map using the 3D map update image. Here, as illustrated in FIG. 16, a case where the 3D map update image transmitted by the client 10B is used as KFz which is new KF will be considered. In this case, since the baseline length between KFx and KFz is longer than the baseline length between KFx and KFy, when KFx and KFz are used, the landmark Li can be estimated with higher accuracy than a case where KFx and KFy are used and a case where KFy and KFz are used.

The above processing in steps S501 to S505 is performed for all the landmarks used for the position and posture estimation.

Note that, in a case where the estimation accuracy of the landmark is high in step S501 (Yes in step S501), the processing ends without performing any of the transmission request for the 3D map update image and the 3D map update. This is because it is not necessary to update the 3D map in a case where the estimation accuracy of the landmark is high.

Furthermore, in step S502, in a case where the client specification unit 106 cannot detect the client 10 capable of transmitting the 3D map update image necessary for updating the landmark Li within the search range (No in step S502), the processing ends without performing any of the transmission request for the 3D map update image and the 3D map update. This is because the transmission request for the 3D map update image cannot be made in a case where the client 10 does not exist.

Then, after updating the 3D map, in a case where the client 10A captures a new position and posture estimation image in step S301 of FIG. 9A and transmits the position and posture estimation image to the information processing apparatus 100 again in step S302 to make a position and posture estimation request, the information processing apparatus 100 receives the position and posture estimation image in step S401 and performs position and posture estimation again in step S402.

At that time, the information processing apparatus 100 performs position and posture estimation of the client 10A using the 3D map updated in step S505. Since the position and posture estimation is performed using the 3D map updated by improving the accuracy of the landmark Li, the position and posture estimation result should be higher than before the update of the 3D map.

In a case where there is a plurality of clients 10 within the search range, the information processing apparatus 100 may request the plurality of clients 10 to transmit the 3D map update image. Then, in a case where the 3D map update images are transmitted from the plurality of clients 10, the 3D map update unit 107 estimates the landmark Li using all the 3D map update images and updates the 3D map. After completion of the update processing, the position and posture estimation unit 102 performs position estimation using the updated 3D map, and the position and posture estimation result is transmitted to the client 10 that has made the position and posture estimation request.

Note that the client 10B that has received the transmission request for the 3D map update image does not necessarily transmit the appropriate 3D map update image including the landmark Li to the information processing apparatus 100. There is also a possibility that a camera image in which the landmark Li does not appear is transmitted, and in this case, the 3D map update unit 107 cannot update the 3D map. Therefore, the information processing apparatus 100 may continuously issue the transmission request for the 3D map update image to all the clients existing in the search range until the 3D map is updated after receiving the 3D map update image.

The processing according to the present technology is performed as described above. According to the present technology, another client 10 capable of transmitting the 3D map update image for improving the accuracy of the landmark included in the 3D map is specified, and a transmission request for the 3D map update image is made to the another client. As a result, the 3D map can be updated using the 3D map update image that cannot be acquired by the client that has made the position and posture estimation request. Since the accuracy of the landmark included in the updated 3D map is improved, the accuracy of the position and posture estimation result of the client that has requested the position and posture estimation can also be improved. Furthermore, the accuracy of drawing of the virtual object in the AR application can also be improved by using the position and posture estimation result with improved accuracy.

### 2. Modifications

Although the embodiment of the present technology has been specifically described above, the present technology is not limited to the above-described embodiment, and various modifications based on the technical idea of the present technology are possible.

In the embodiment, it has been described that one information processing apparatus 100 performs processing in the server 20, but the information processing apparatus 100 may be divided into a plurality of information processing apparatuses by its function, and processing may be performed in different servers.

Although the description has been given assuming that there is one server 20 in the embodiment, the number of servers 20 is not limited. The present technology may be combined with a 3D map update method using a plurality of servers 20. This can reduce the time taken to update the 3D map.

The present technology may also have the following configurations.

(1)

An information processing apparatus including:
an estimation accuracy determination unit that determines estimation accuracy of a position and a posture of a client estimated on the basis of a position and posture estimation image obtained by imaging a real space transmitted from the client and a 3D map of the real space; and
a client specification unit that specifies another client that requests transmission of a 3D map update image for updating the 3D map on the basis of a determination result of the estimation accuracy.
   (2)

The information processing apparatus according to (1), in which in a case where the estimation accuracy determination unit determines that the estimation accuracy of the position and the posture of the client is low, the client specification unit specifies the another client that requests transmission of the 3D map update image.

(3)

The information processing apparatus according to (2), in which in a case where the estimation accuracy determination unit determines that the estimation accuracy of the position and the posture of the client is low, the estimation accuracy determination unit determines accuracy of a landmark included in the 3D map and used for estimating the position and the posture of the client, and in a case where the accuracy of the landmark is low, the client specification unit specifies the another client that requests transmission of a 3D map update image.

(4)

The information processing apparatus according to (3), in which the accuracy of the landmark is calculated on the basis of a distance between a plurality of keyframes used for estimating the landmark and a distance between each of the plurality of keyframes and the landmark included in the 3D map.

(5)

The information processing apparatus according to any one of (1) to (4), in which the estimation accuracy determination unit determines the estimation accuracy of the position and the posture by comparing a predetermined threshold with an average of distances between a position of a landmark used for estimating the position and the posture of the client and the estimated position of the client included in the 3D map.

(6)

The information processing apparatus according to any one of (1) to (5), in which the client specification unit specifies the another client that requests transmission of the 3D map update image within a search range on the basis of position information transmitted from the another client.

(7)

The information processing apparatus according to (6), in which the search range is a range determined on a basis of an imaging position of a key frame included in the 3D map and a distance between landmarks with reference to the landmark included in the 3D map and used for estimating the position and the posture of the client.

(8)

The information processing apparatus according to any one of (1) to (7), further including a 3D map update unit that updates the 3D map using the 3D map update image transmitted from the another client.

(9)

The information processing apparatus according to (8), in which the 3D map update unit estimates a position of the landmark by triangulation using a positional relationship between the 3D map update image and a feature point in a key frame included in the 3D map, and updates the 3D map.

(10)

The information processing apparatus according to any one of (1) to (9), further including a position and posture estimation unit that estimates the position and the posture of the client on the basis of the position and posture estimation image transmitted from the client and the 3D map.

(11)

The information processing apparatus according to any one of (1) to (10), in which a key frame included in the 3D map and used for estimating a landmark is displayed on a display unit included in the another client that has received the transmission request for the 3D map update image.

(12)

The information processing apparatus according to (11), in which information on a direction in which the landmark exists is displayed on the display unit.

(13)

The information processing apparatus according to any one of (1) to (12), in which a transmission request for the 3D map update image is made to another client different from the client that has transmitted the position and posture estimation image.

(14)

A program for causing a computer to execute an information processing method, the information processing method including:
determining estimation accuracy of a position and a posture of a client estimated on the basis of a position and posture estimation image obtained by imaging a real space transmitted from the client and a 3D map of the real space; and
specifying another client that requests transmission of a 3D map update image for updating the 3D map on the basis of a determination result of the estimation accuracy.
   (15)

An information processing system including:
a client that transmits a position and posture estimation image obtained by imaging a real space and makes a position and posture estimation request;
an information processing apparatus including
   an estimation accuracy determination unit that determines estimation accuracy of a position and a posture of the client estimated on the basis of the position and posture estimation image and a 3D map of the real space, and
   a client specification unit that specifies another client that requests transmission of a 3D map update image for updating the 3D map on the basis of a determination result of the estimation accuracy; and
another client that transmits the 3D map update image in response to a request for transmission of the 3D map update image from the information processing apparatus.

### REFERENCE SIGNS LIST

10 Client
100 Information processing apparatus
102 Position and posture estimation unit
103 Estimation accuracy determination unit
104 3D map accuracy determination unit
106 Client specification unit
107 3D map update unit
1000 Information processing system

1. An information processing apparatus comprising:
an estimation accuracy determination unit that determines estimation accuracy of a position and a posture of a client estimated on a basis of a position and posture estimation image obtained by imaging a real space transmitted from the client and a 3D map of the real space; and
a client specification unit that specifies another client that requests transmission of a 3D map update image for updating the 3D map on a basis of a determination result of the estimation accuracy.

2. The information processing apparatus according to claim 1, wherein
in a case where the estimation accuracy determination unit determines that the estimation accuracy of the position and the posture of the client is low, the client specification unit specifies the another client that requests transmission of the 3D map update image.

3. The information processing apparatus according to claim 2, wherein
in a case where the estimation accuracy determination unit determines that the estimation accuracy of the position and the posture of the client is low, the estimation accuracy determination unit determines accuracy of a landmark included in the 3D map and used for estimating the position and the posture of the client, and in a case where the accuracy of the landmark is low, the client specification unit specifies the another client that requests transmission of a 3D map update image.

4. The information processing apparatus according to claim 3, wherein
the accuracy of the landmark is calculated on a basis of a distance between a plurality of keyframes used for estimating the landmark and a distance between each of the plurality of keyframes and the landmark included in the 3D map.

5. The information processing apparatus according to claim 1, wherein
the estimation accuracy determination unit determines the estimation accuracy of the position and the posture by comparing a predetermined threshold with an average of distances between a position of a landmark used for estimating the position and the posture of the client and the estimated position of the client included in the 3D map.

6. The information processing apparatus according to claim 1, wherein
the client specification unit specifies the another client that requests transmission of the 3D map update image within a search range on a basis of position information transmitted from the another client.

7. The information processing apparatus according to claim 6, wherein
the search range is a range determined on a basis of an imaging position of a key frame included in the 3D map and a distance between landmarks with reference to the landmark included in the 3D map and used for estimating the position and the posture of the client.

8. The information processing apparatus according to claim 1, further comprising
a 3D map update unit that updates the 3D map using the 3D map update image transmitted from the another client.

9. The information processing apparatus according to claim 8, wherein
the 3D map update unit estimates a position of the landmark by triangulation using a positional relationship between the 3D map update image and a feature point in a key frame included in the 3D map, and updates the 3D map.

10. The information processing apparatus according to claim 1, further comprising
a position and posture estimation unit that estimates the position and the posture of the client on a basis of the position and posture estimation image transmitted from the client and the 3D map.

11. The information processing apparatus according to claim 1, wherein
a key frame included in the 3D map and used for estimating a landmark is displayed on a display unit included in the another client that has received the transmission request for the 3D map update image.

12. The information processing apparatus according to claim 11, wherein
information on a direction in which the landmark exists is displayed on the display unit.

13. The information processing apparatus according to claim 1, wherein
a transmission request for the 3D map update image is made to another client different from the client that has transmitted the position and posture estimation image.

14. A program for causing a computer to execute an information processing method, the information processing method including:
determining estimation accuracy of a position and a posture of a client estimated on a basis of a position and posture estimation image obtained by imaging a real space transmitted from the client and a 3D map of the real space; and
specifying another client that requests transmission of a 3D map update image for updating the 3D map on a basis of a determination result of the estimation accuracy.

15. An information processing system comprising:
a client that transmits a position and posture estimation image obtained by imaging a real space and makes a position and posture estimation request;
an information processing apparatus including
an estimation accuracy determination unit that determines estimation accuracy of a position and a posture of the client estimated on a basis of the position and posture estimation image and a 3D map of the real space, and
a client specification unit that specifies another client that requests transmission of a 3D map update image for updating the 3D map on a basis of a determination result of the estimation accuracy; and
another client that transmits the 3D map update image in response to a request for transmission of the 3D map update image from the information processing apparatus.
